(19) United States
(12) Patent Application Publication
(10) Pub. No.: US 2002/0001515 A1
(43) Pub. Date: Jan. 3, 2002

(54) HOISTING APPARATUS FOR A STRADDLE CARRIER

(76) Inventors: JUHANI LUKUMAA, HYVINKAA (FI); JORMA NURMI, TAMPERE (FI)

Correspondence Address: STEINBERG & RASKIN PC, 1140 AVENUE OF THE AMERICAS, NEW YORK, NY, 10036

(21) Appl. No.: 09/334,089

(22) Filed: Jun. 16, 1999

(30) Foreign Application Priority Data
Jun. 16, 1998 (FI) 981395

(51) Int. Cl. B66C 5/00; B66C 13/06; B66D 3/00

(52) U.S. Cl. 414/460; 254/386; 212/274

(57) ABSTRACT

A hoisting apparatus for a straddle carrier having a spreader with a frame part having a plurality of lifting points, a plurality of hoisting cables each having a first and second end, a top frame having a hoisting mechanism and a first set of cable pulleys. The hoisting mechanism includes a lifting cylinder and a piston movably arranged within the lifting cylinder, and a second set of cable pulleys mounted onto the top frame, such that the second set of cable pulleys is driven by the extension of the piston and the hoisting cables are passed over the first set of cable pulleys and the second set of cable pulleys, respectively. The second end of the hoisting cables is connected to the hoisting mechanism wherein upon extension of the piston out of the lifting cylinder produces a lifting movement that is of an equal magnitude for each of the plurality of hoisting cables. As such, regardless of a tilting moment caused by an eccentricity of the load, each lifting points of the spreader is arranged to synchronously move an equal distance and hoist the load carried by the spreader in a substantially horizontal position.

### FIELD OF THE INVENTION

The present invention relates to a hoisting apparatus for a straddle carrier including a spreader having a frame part with four separate lifting points from which hoisting cables used as a hoisting means are passed over cable pulleys, intermediate pulleys or equivalent to a hoist mechanism situated on a top frame of the straddle carrier.

### BACKGROUND OF THE INVENTION

Conventionally, straddle carriers employ two different techniques for hoisting containers, namely chain hoisting and cable hoisting. In chain hoisting, four chains which run from a hoist mechanism situated on a top frame of a straddle carrier to the corners of a frame part of a spreader are used as the hoisting means. The spreader is a so-called top-lift spreader by which the upper comers of a container are grasped from above. The hoist mechanism comprises two separate lifting cylinders, situated on the sides of the top frame of the straddle carrier, and further separate sets of sprockets situated on the sides of the top frame. A lifting movement is produced by displacing the sprocket sets by means of the lifting cylinders in a horizontal direction, whereby the displacement of the sprocket sets produces a lifting movement with a transmission ratio which depends on the number of the sprockets in the sprocket sets. Hydraulic cylinders are generally used as lifting cylinders. The center of gravity of the container that is being lifted may be situated eccentrically, with the result that this eccentricity of the load causes a tilting moment. The tilting moment is eliminated by connecting the separate sets of sprockets on either side of the top frame together by means of a differential axle mounted between the sets of sprockets.

In cable hoisting, a steel cable wound round a hoist drum is used as the lifting means. The cable runs from the hoist drum to each corner of the frame part of the spreader. The drive of the hoist drum may be provided either electrically or hydraulically. The hoist drum may be situated on a top frame or it may be situated on a base frame on one side of the straddle carrier. One example of such an arrangement is the construction described in published European Patent Application No. 763 497, which is hereby incorporated by reference. Cable transmission may be selected so as to be appropriate in accordance with the guidelines provided by normal crane standards.

For the operator, there are, among other things, the following differences in the lifting techniques that are conventionally used. From the technical standpoint it is simpler to provide chain hoisting than cable hoisting. If the required lifting height is low, generally less than about 10 m, then it is technically more appropriate and easier to use a lifting cylinder than a rotating drum for producing a lifting movement. In this regard, chain hoisting is simpler than cable hoisting, and thus more reliable. As such, chain hoisting is preferable to cable hoisting. In order to make the service life of the lifting means (chain/cable) sufficiently long it is necessary to lubricate the chains and grease the cable. From the environmental standpoint, greasing of a cable requires considerably less lubricants than the lubrication of chains, and thus the impact on the environment is smaller when cable hoisting is used. In this respect, cable hoisting is preferable to chain hoisting. As lifting means, the cable is substantially more advantageous in its purchase price than the chain, but, on the other hand, the service life of chains is much longer than the service life of cables. In this regard, the lifting techniques are of equal value. Maintenance services, such as, replacement of the hoisting means in the hoist mechanism, can be performed in the cable hoisting technique considerably more easily and more quickly than in the chain lifting technique mainly for the reason that, as a hoisting means, the cable is substantially lighter in weight than the chain. In this respect, cable hoisting is preferable to chain hoisting.

### OBJECTS AND SUMMARY OF THE INVENTION

An object of the present invention is to provide a novel hoisting system for a straddle carrier which makes it possible to make use of and combine the advantages of both of the previously known lifting techniques, i.e., cable hoisting and chain hoisting.

Another object of the present invention is to provide a hoisting apparatus for a straddle carrier that hoists loads in a substantially horizontal manner.

In order to achieve these and other objects, the hoist mechanism in accordance with the invention comprises a lifting cylinder and a piston and includes a cable pulley set structure mounted on a top frame. The cable pulley set structure is driven by the lifting cylinder and includes first and second cable pulleys. Each hoisting cable is passed to the cable pulley set structure. A lifting movement is produced by means of the lifting cylinder by changing the distance between the first and second cable pulleys such that an extension of the piston out of the lifting cylinder produces a lifting movement of equal magnitude for each hoisting cable. As such, regardless of the tilting moment caused by the eccentricity of load, each lifting point of a spreader is arranged to synchronously move an equal distance and hoist the load connected to the spreader substantially in a horizontal position.

The new hoisting system in accordance with the invention is based on cable hoisting which, however, makes use of a lifting cylinder and a piston in producing a lifting movement so that the structure is uncomplicated, reliable, and advantageous with regard to the environmental impact and the ease of servicing. The cable transmission of the lifting movement can easily be made as desired according to the need in order to provide a sufficient lifting height and lifting speed. The tilting moment caused by the eccentricity of the load being hoisted can be easily eliminated in the system in accordance with the invention.

Other advantages and characteristic features of the invention will come out from the following detailed description of the invention.

The invention will be described in detail with reference to some preferred embodiments of the invention illustrated in the figures in the accompanying drawings. However, the invention is not confined to the illustrated embodiments alone.

### BRIEF DESCRIPTION OF THE DRAWINGS

Additional objects of the invention will be apparent from the following description of the preferred embodiment thereof taken in conjunction with the accompanying non-limiting drawings, in which:

FIGS. 1 and 2 generally show a straddle carrier to which the hoisting system in accordance with the invention can be applied, FIG. 1 showing the straddle carrier from the side and FIG. 2 showing it from the front in a corresponding way;

FIG. 3 shows a first embodiment of a hoist mechanism mounted on a top frame of a straddle carrier seen from above;

FIG. 4A is a schematic and partial sectional view along the line 4A-4A from FIG. 3;

FIG. 4B is a schematic and partial sectional view along the line 4B-4B from FIG. 3;

FIG. 5 is an illustration corresponding to that of FIG. 3 of a second embodiment of the invention; and

FIG. 6 is a schematic and partial sectional view along the line 6-6 from FIG. 5.

### DETAILED DESCRIPTION OF THE PREFERRED EMBODIMENTS

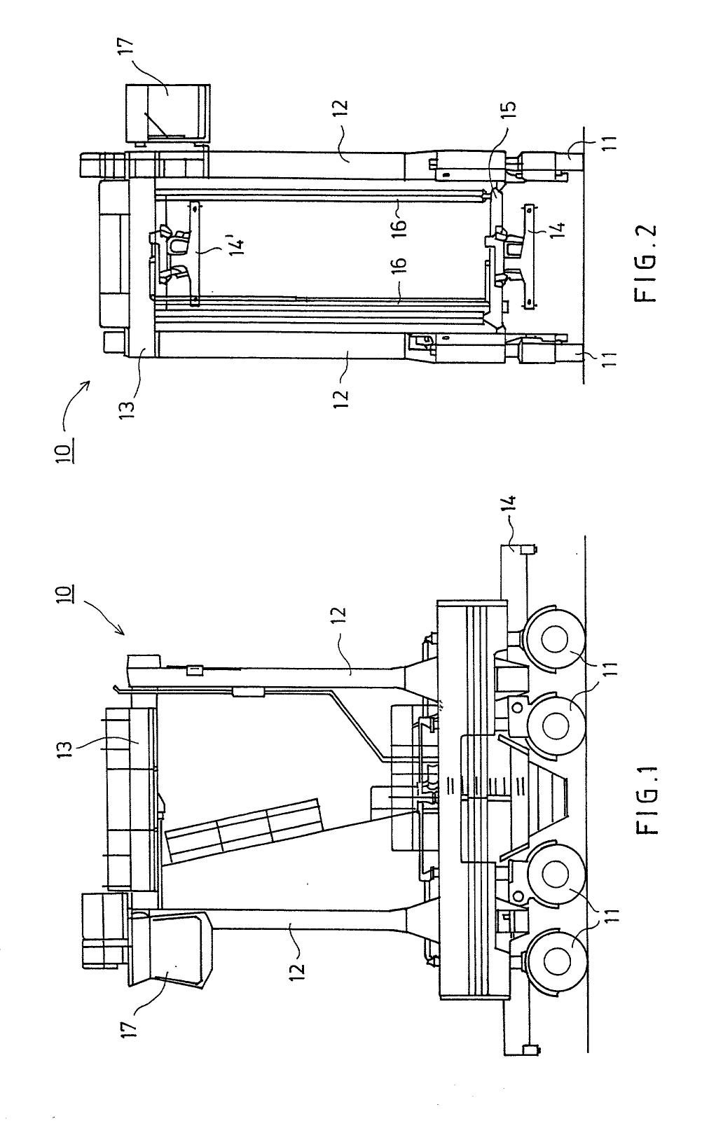

Referring to FIGS. 1-6 wherein like reference numerals refer to the same or similar elements, in FIGS. 1 and 2, a straddle carrier is generally designated by reference numeral 10. The straddle carrier 10 comprises wheels 11 situated on both sides of the machine and which support substantially vertical support legs 12. A top frame 13 of the machine is arranged on the upper end of the support legs 12, and a hoist mechanism (not shown in FIGS. 1 and 2) is mounted on support of the top frame 13. A spreader 14 is suspended from the hoist mechanism by means of cables 16. Spreader 14 is vertically movable and arranged to grasp containers for the purpose of transferring them. The cables 16 pass to a frame part 15 of the spreader 14, on whose support the spreader 14 itself is situated. In FIG. 2, the spreader 14 is shown both in its lower position 14 and in its upper position 14′, designated.

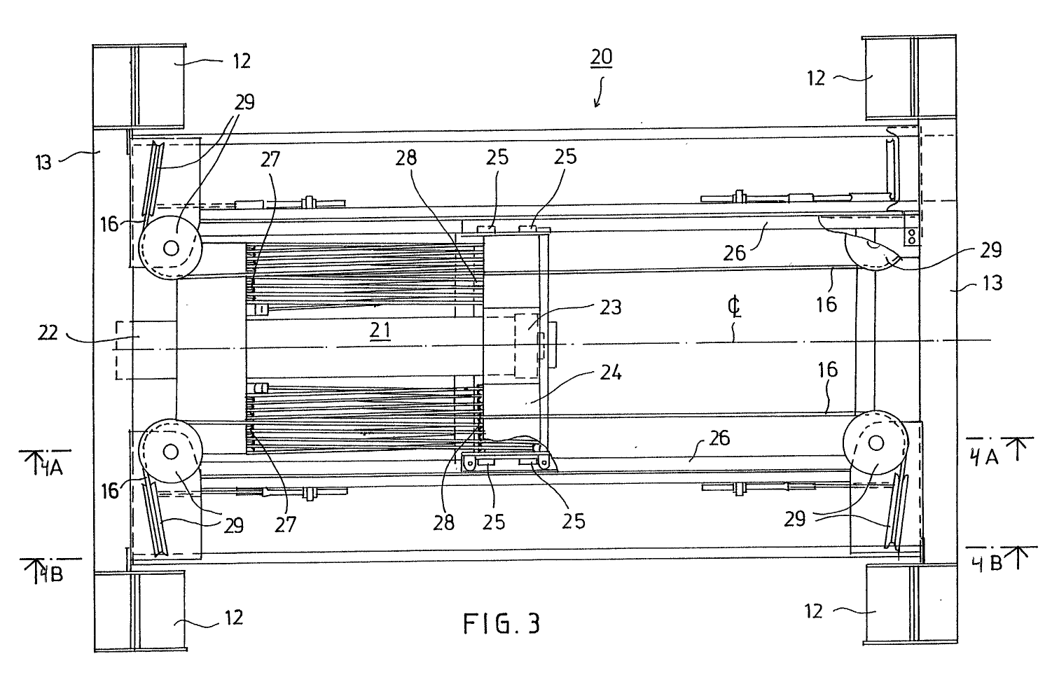

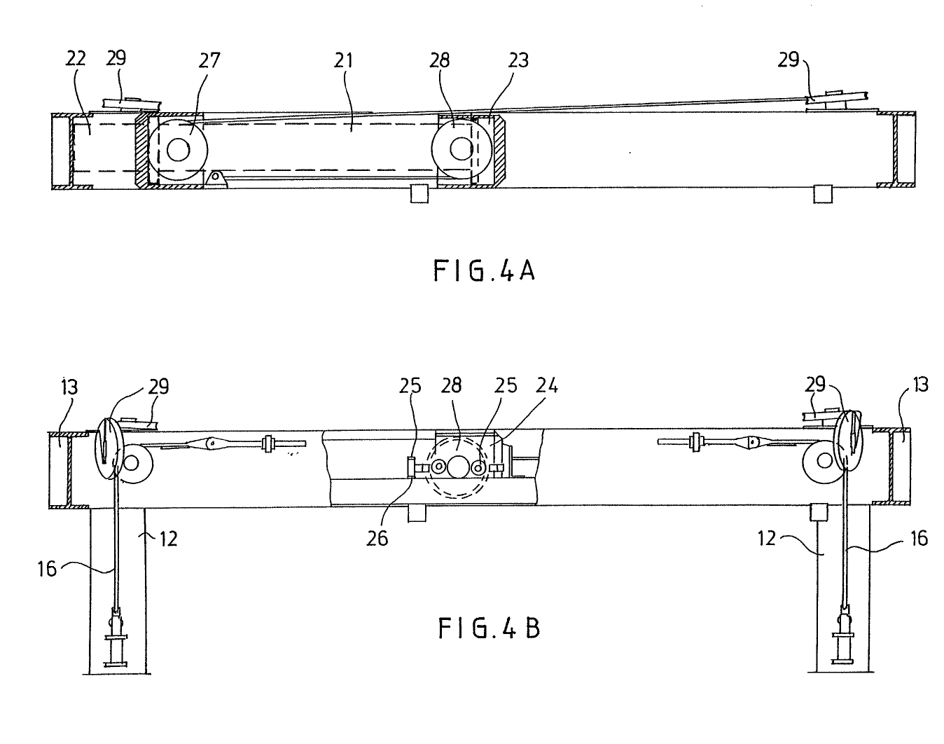

FIGS. 3, 4A and 4B show one embodiment of a hoisting apparatus applied in a straddle carrier. FIG. 3 illustrates the hoisting apparatus from above, FIG. 4A is a partial sectional view along the line 4A-4A from FIG. 3 and, in a corresponding way, FIG. 4B is a partial sectional view along the line 4B-4B from FIG. 3. In FIGS. 3, 4A and 4B, the hoisting apparatus is generally designated by reference numeral 20. The hoisting apparatus 20 comprises a lifting cylinder 21 mounted on the top frame 13 of the straddle carrier and horizontally disposed on the longitudinal center axis C of the straddle carrier, which lifting cylinder is fixed to the top frame 13 at its first end, i.e., in the embodiment shown in FIG. 3, 4A and 4B, at the end 22 on the cylinder side. The second end 23 of the lifting cylinder 21, i.e. the end situated on the piston side, is mounted on a carriage 24, which is provided with rollers 25 or equivalent, which move along guides 26 provided on the top frame 13 when the lifting cylinder 21 is operated. The rollers 25 and guides 26 constitute guidance means for guiding the carriage 24 on the top frame 13.

The hoisting system in accordance with the invention is based on cable lifting, and thus the hoisting apparatus comprises a cable pulley set structure, which includes, firstly, first cable pulleys 27 mounted on the top frame 13 and freely rotating on an axle transverse to the length of the lifting cylinder 13. Further, the cable pulley set structure includes second cable pulleys 28, each having an axle mounted on the lifting cylinder 21 such that the second cable pulleys 28 move with the extension of the piston 23 out of lifting cylinder 21. When the lifting cylinder 21 is operated, the distance between the first cable pulleys 27 and second cable pulleys 28 thus t5 changes. The hoisting cables 16 are attached to each of the four corners of the frame part 15 of the spreader. The hoisting cables 16 being passed over cable pulleys 29 to the cable pulley set structure comprising the lifting cylinder 21 and the first cable pulleys 27 and second cable pulleys 28 such that each hoisting cable 16 passes over the first cable pulleys 27 and second cable pulleys 28. In the embodiments shown in FIGS. 3, 4A and 4B, the hoisting cables 16 are attached, at one end, specifically to the frame part 15 of the spreader and, at the opposite end, the hoisting cables 16 are attached to the top frame 13. Each hoisting cable 16 passes through an equal number of turns or as an equal number of loops around the cable pulley set structure formed by the first cable pulleys 27 and second cable pulleys 28, thereby providing a desired transmission ratio for the cable transmission. The horizontal movement produced by means of the extension of the piston 23 out of the lifting cylinder 21 is transmitted through the cable pulleys 27, 28 and 29 of the cable pulley set as a vertical movement of equal magnitude to each hoisting cable 16. The movement of equal magnitude for the hoisting cables 16 is produced such that all the hoisting cables 16 are passed over the cable pulleys to one and the same cylinder/cable pulley set structure (21, 27 and 28), so that each hoisting cable 16 runs the same distance keeping the container in a horizontal position. The balancing problem of the lifting movement is specifically solved such that all the hoisting cables 16 are passed to the same point. A differential axle applied in chain hoisting cannot be employed in connection with cable pulleys, because there may occur slipping between the hoisting cables and the cable pulleys. A suitable transmission ratio of the horizontal movement the piston 23 out of the lifting cylinder 21 to the vertical lifting movement is provided by selecting for the cable pulley set structure a suitable number of cable pulleys 27 and 28, over which the hoisting cables 16 are caused to run.

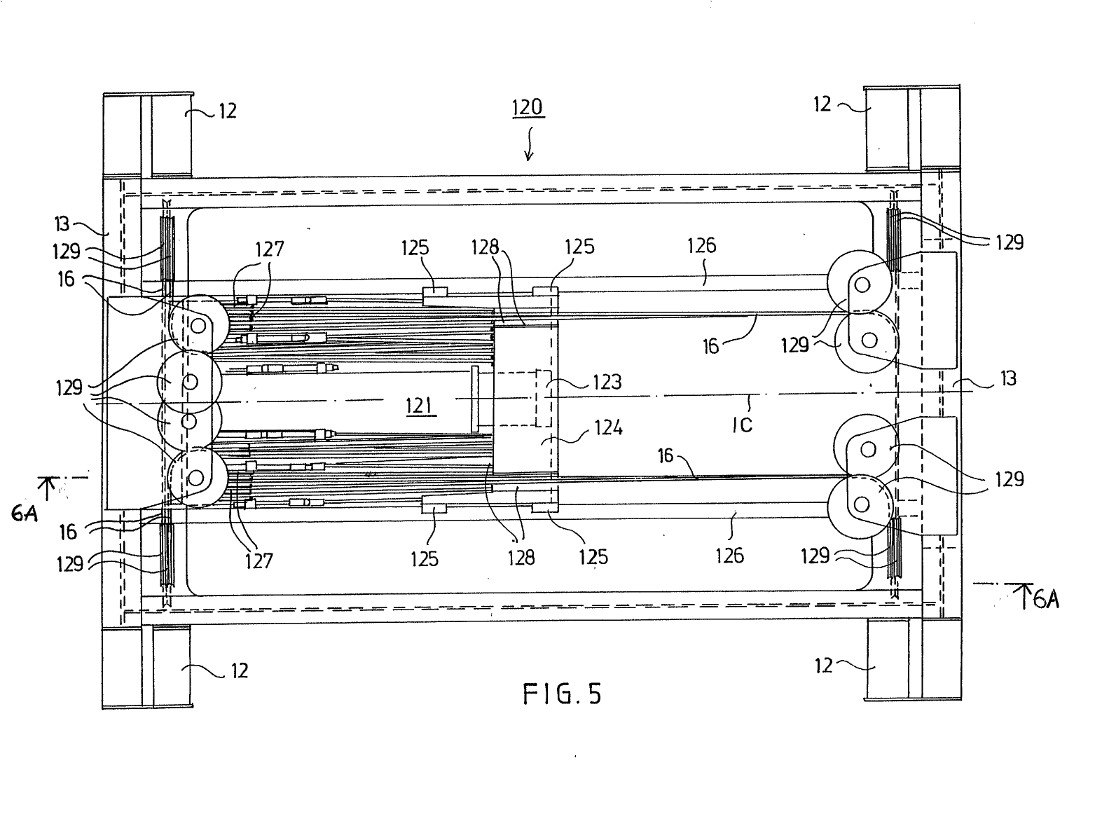

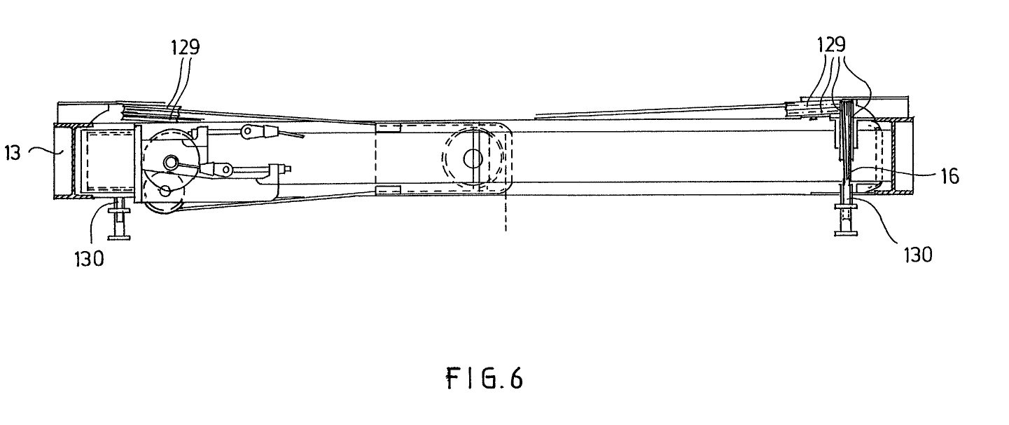

FIGS. 5 and 6 show a second embodiment of the hoisting apparatus in accordance with the invention, FIG. 5 showing the hoisting apparatus seen from above in a way corresponding to that of FIG. 3 and FIG. 6 being a partial sectional view along the line 6A-6A from FIG. 5. In FIGS. 5 and 6, the hoisting apparatus is generally designated by reference numeral 120. In a way corresponding to that shown in FIG. 3, a lifting cylinder is designated by reference numeral 121, a piston part of the cylinder is designated by reference numeral 123, a carriage moving with the piston part is designated by reference numeral 124, and first and second cable pulleys are designated by reference numerals 127 and 128. In this respect, the structure of the hoisting apparatus corresponds to that shown in FIG. 3. The guides formed on the top frame 13 for the carriage 124 are designated, in a similar way, with reference numerals 126 and the slide parts of the carriage 124 moving along the guides 126 are designated by reference numerals 125.

The most significant differences of the arrangement shown in FIGS. 5 and 6 with respect to the arrangement shown in FIGS. 3, 4A and 4B are that, first, in the illustration of FIGS. 5 and 6, the corners of the frame part 15 of the spreader are provided with return pulleys 130, over which the hoisting cables 16 run. Thus, the hoisting cables 16 run from the cable pulleys 127 and 128 of the cable pulley set structure over separate cable pulleys 129 to the frame part 15 of the spreader and return over the return pulleys 130 back to the cable pulley set structure over cable pulleys 129. As a result, there are twice as many cable pulleys 129 as compared with the embodiment illustrated in FIGS. 3, 4A and 4B. As such, in the arrangement of FIGS. 5 and 6, one end of the hoisting cables 16 is attached, in the cable pulley set structure, to a rear end of the cylinder 121 on a side of the cylinder 121 that is different, with respect to a longitudinal center line 1C, from the side where the opposite end of the hoisting cable 16 is attached. It is an advantage that this arrangement allows the lifting cylinder 121 to be balanced regardless of the eccentricity of the load hanging on support of the hoisting cables 16.

The structure comprising the lifting cylinder 121 and the cable pulley set 127 and 128 may be accomplished such that the second cable pulleys 128 of the cable pulley set are attached directly to the end of the piston part 123 of the lifting cylinder, in which case, the lifting cylinder 121 itself carries the additional forces caused by the lateral eccentricity of the load. On the other hand, the arrangement may be similar to that shown in FIG. 5 such that the carriage 124 is pivotally connected to the piston part 123 of the lifting cylinder 121, in which case, the cable pulley set structure requires external guidance in the form of guidance means for guiding the cable pulley set structure and connected to the top frame. The guidance means may be the guides 126 and the slide parts 125 as shown in FIG. 5, or other suitable equivalent, such as rollers.

In summary of the invention the following may be further stated. The feature common to the different embodiments of the invention is that the support forces from the four corners of the frame part 15 of the spreader, i.e,. all four hoisting cables 16, are passed over the cable pulleys to one and the same cylinder-operated cable pulley set structure. This accomplishes that each lifting point in the spreader synchronously moves the same distance, and the load that is being hoisted, i.e., the container, remains in a horizontal position regardless of the tilting moment caused by the eccentricity of the load. A desired transmission ratio for the hoisting structure is obtained such that a multiple pulley system, i.e., a necessary number of first and second cable pulleys, is used in the cable pulley set structure. Further, the hoisting cables may be attached either directly to the frame part of the spreader or they may be arranged to be passed over return pulleys back to the cable pulley set structure. The cable pulley set may be mounted rigidly to the end of the lifting cylinder, in which case the lifting cylinder itself carries and receives the additional forces caused by the lateral eccentricity of the container being hoisted. On the other hand, the cable pulley set structure may be attached to the end of the cylinder by means of an articulation joint, in which case external guidance is required for receiving the additional forces being produced. If the hoisting cables are arranged to run over the return pulleys provided on the frame part of the spreader, the hoisting cables may be attached at one end thereof to the rear end of the lifting cylinder and at the other end to the top frame. On the other hand, both ends of the hoisting cables may be attached to the rear end of the lifting cylinder on different sides of the cylinder with respect to the center line in order to balance the lifting cylinder regardless of eccentric load.

Above, some preferred embodiments of the invention have been described, and it is obvious to a person skilled in the art that numerous modifications can be made to these embodiments within the scope of the inventive idea defined in the accompanying patent claims. As such, the examples provided above are not meant to be exclusive. Many other variations of the present invention would be obvious to those skilled in the art, and are contemplated to be within the scope of the appended claims.

We claim:

1. A hoisting apparatus for a straddle carrier, comprising
a spreader for carrying a load, said spreader including a frame part having a plurality of lifting points,
a plurality of hoisting cables, each having a first and second end,
a top frame,
a hoisting mechanism arranged on said top frame,
said hoisting mechanism comprising,
a lifting cylinder and a piston movably arranged within said lifting cylinder, and
a cable set structure driven by said lifting cylinder comprising,
a first set of cable pulleys, and
a second set of cable pulleys mounted onto said top frame such that said second set of cable pulleys are driven by said piston,
said plurality of hoisting cables being passed to said cable set structure and said second end of each of said hoisting cables being connected to said hoisting mechanism wherein upon extension of said piston out of said lifting cylinder produces a lifting movement that is of an equal magnitude for each of said plurality of hoisting cables.

2. The hoisting apparatus of claim 1, wherein said hoisting apparatus is structured and arranged such that regardless of a tilting moment caused by an eccentricity of the load each of said lifting points of said spreader synchronously moves an equal distance and hoists the load carried by said spreader in a substantially horizontal position.

3. The hoisting apparatus of claim 1 wherein said plurality of hoisting cables being passed to said cable set structure are passed over said first set of cable pulleys and said second set of cable pulleys.

4. The hoisting apparatus of claim 3, wherein said second set of cable pulleys is arranged to form a multiple pulley system for each of said hoisting cables and produces a desired transmission ratio for hoisting the load.

5. The hoisting apparatus of claim 4, wherein said first set of cable pulleys of said cable pulley set structure are rigidly mounted to said lifting cylinder, such that said lifting cylinder is structured and arranged to carry additional forces cause by lateral eccentricity of the load being lifted.

6. The hoisting apparatus of claim 5, wherein said second set of cable pulleys of said cable set structure is rigidly mounted to said piston such that said lifting cylinder and said piston are arranged to carry additional forces caused by lateral eccentricity of the load being lifted.

7. The hoisting apparatus of claim 5, wherein said second set of cable pulleys of said cable pulley set structure are pivotally mounted to said piston.

8. The hoisting apparatus of claim 5, wherein said top frame further comprises
means for guidance for guiding said second set of cable pulleys in order to receive lateral forces.

9. The hoisting apparatus of claim 8, further comprising
a carriage mounted to said piston adapted to be guided by said guiding means.

10. The hoisting apparatus of claim 9, wherein said guiding means comprise
a plurality of guides extending in the direction of movement of said piston.

11. The hoising apparatus of claim 10, wherein said guiding means further comprise a set of rollers adapted to engage said plurality of guides.

12. The hoisting apparatus of claim 10, wherein said guiding means comprise a set of slides adapted to engage said plurality of guides.

13. The hoisting apparatus of claim 1, wherein said second end of each of said hoisting cables is connected to a respective one of said lifting points.

14. The hoisting apparatus as claimed 1, wherein said frame part further comprises a set of return pulleys over which said hoisting cables are passed.

15. The hoisting apparatus of claim 14, wherein said second ends of said hoisting cables are connected to said lifting cylinder.

16. The hoisting apparatus of claim 13, wherein said first and second ends of said hoisting cables are attached to said lifting mechanism.

17. The hoisting apparatus of claim 16, wherein said first and second ends of said hoisting cables are connected to opposing sides of said lifting cylinder, respectively, and arranged with respect to the length of said lifting cylinder in order to balance said lifting cylinder regardless of eccentric load.
